(19) United States
(12) Patent Application Publication
(10) Pub. No.: US 2024/0327726 A1
(43) Pub. Date: Oct. 3, 2024

(54) PROCESSING WATER FROM HYDROCARBON OPERATIONS

(71) Applicant: SAUDI ARABIAN OIL COMPANY, Dhahran (SA)

(72) Inventors: Ahmed S. AL-OTAIBI, Dhahran (SA); Mustafa A. AL-JUBRAN, Dhahran (SA)

(73) Assignee: SAUDI ARABIAN OIL COMPANY, Dhahran (SA)

(21) Appl. No.: 18/194,849

(22) Filed: Apr. 3, 2023

(51) Int. Cl. C10G 33/06; A01G 33/00; B01D 17/02; B01D 17/04; B01D 53/62; C02F 1/40

(52) U.S. Cl. CPC C10G 33/06; A01G 33/00; B01D 17/0217; B01D 17/045; B01D 53/62; C02F 1/40; B01D 2257/504; B01D 2258/0283; C02F 2303/22; C10G 2300/202; C10G 2300/205; C10G 2300/4043; C10G 2300/4056; C10G 2300/708

(57) ABSTRACT

Mineral-rich streams of water may be processed using a method including separation. For example, a method may include: providing a first production stream and a second production stream, wherein both the first production stream and the second production stream comprise hydrocarbons and water, and wherein the first production stream contains carbonates and/or sulfates and the second production stream contains minerals, such that if the first production stream and the second production stream were combined scale would form; either (i) separating the first production stream into a first aqueous stream and a first hydrocarbon stream, wherein the first aqueous stream includes the carbonates and/or sulfates or (ii) separating the second production stream into a second aqueous stream and a second hydrocarbon stream, wherein the second aqueous stream includes the minerals; and combining the first hydrocarbon stream and the second production stream for further processing.

### FIELD OF THE DISCLOSURE

The present disclosure relates generally to hydrocarbon processing and, more particularly, to processing of water from hydrocarbon operations.

### BACKGROUND OF THE DISCLOSURE

Formation water is water that occurs naturally within geological formations and may be removed to the surface in hydrocarbon production operations, such that the production stream is a production stream that includes not just the desirable hydrocarbons (oil, gas, etc.) but also produced water and organic and inorganic impurities. Such a produced solution may be destined for processing through a gas-oil separation plant (GOSP). Because formation water within hydrocarbon solutions may comprise various impurities, treatment and/or purification is typically required prior to release into the environment. Conventional formation water purification includes equipment within GOSP systems, such as dosing and dilution systems. Such dilution and chemical addition may require costly precise monitoring to treat impurities in the hydrocarbon solution appropriately.

Produced water sources must be treated for disposal, injection as a liquid, or injection as steam with three types of facilities. Produced water is treated in offshore operations for overboard disposal or injection into a disposal well, but when onshore, it is treated for surface disposal, liquid injection, or steam injection. In all instances, the produced water must be cleaned of dispersed and dissolved oil and solids to a level suitable for environmental, reservoir, or steam-generation purposes.

In some cases, the produced water may contain high levels of dissolved minerals and other compounds such as sulfate, calcium, potassium, the like, or a combination thereof. Conventional systems for hydrocarbon processing that deal with formation water may encounter issues with scale formation, in particular if hydrocarbon solutions being processed include significant minerals dissolved therein. Conventional methods for mitigating scale involve additional solution dilution, precision separation, and addition of scale inhibitor chemicals-all of which can add cost and complexity to hydrocarbon processing operations.

### SUMMARY OF THE DISCLOSURE

Various details of the present disclosure are hereinafter summarized to provide a basic understanding. This summary is not an exhaustive overview of the disclosure and is intended neither to identify certain elements of the disclosure, nor to delineate the scope thereof. Rather, the primary purpose of this summary is to present some concepts of the disclosure in a simplified form prior to the more detailed description that is presented hereinafter.

A first nonlimiting example integrated method of the present disclosure includes: providing a first production stream and a second production stream, wherein both the first production stream and the second production stream comprise hydrocarbons and water, and wherein the first production stream contains carbonates and/or sulfates and the second production stream contains minerals, such that if the first production stream and the second production stream were combined scale would form; either (i) separating the first production stream into a first aqueous stream and a first hydrocarbon stream, wherein the first aqueous stream comprises the carbonates and/or sulfates or (ii) separating the second production stream into a second aqueous stream and a second hydrocarbon stream, wherein the second aqueous stream comprises the minerals; and combining the first hydrocarbon stream and the second production stream for further processing.

A second nonlimiting example integrated method of the present disclosure includes: providing a first production stream and a second production stream, wherein both the first production stream and the second production stream comprise hydrocarbons and water; wherein the first production stream contains carbonates and/or sulfates and the second production stream contains minerals, such that if the first production stream and the second production stream were combined scale would form; separating the first production stream into a first aqueous stream and a first hydrocarbon stream, wherein the first aqueous stream comprises water and carbonates and/or sulfates; combining the first hydrocarbon stream and the second production stream for further processing; cultivating algae in a fluid comprising the first aqueous stream; and harvesting the algae to produce harvested algae, wherein the harvested algae comprises algae solids, algae liquids, algae lipids, or any combination thereof.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 shows a diagram of a comparative example system according to the present disclosure.

FIG. 2 shows a diagram of a nonlimiting example system according to the present disclosure.

FIG. 3 shows a flow diagram of a nonlimiting example integrated method according to the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to hydrocarbon processing and, more particularly, to processing of water from hydrocarbon operations.

Some embodiments describe a method of processing produced water from more than one reservoir such that scale formation is inhibited to streamline operations.

Other embodiments disclose methods and systems for further processing produced water from hydrocarbon operations using integrated systems to introduce an algae system for the further treatment of produced water that has been separated from the hydrocarbon components in the production stream. Such integrated solutions allow for cost-effective and environmentally sustainable treatment of produced water from hydrocarbon operations and may allow for supply of value-added products from algae treatment of water.

“Production stream” as used herein, refers to a mixture generally comprised of hydrocarbons (e.g., oil, gas, the like, or any combination thereof), water (e.g., formation water), and potentially some contaminants from a reservoir. Embodiments of the present invention may be well suited to situations where more than one production stream is treated, wherein the production streams originate from different subterranean reservoirs.

“Subterranean reservoir” or “reservoir” as used herein, refers to a deposit of hydrocarbons within a subterranean formation. The reservoir may be extracted from utilizing a well or other similar such systems. Where reference is made to a first reservoir and a second reservoir, etc. it should be understood that such reservoirs are generally not in substantial fluid communication and thus may have different chemical compositions.

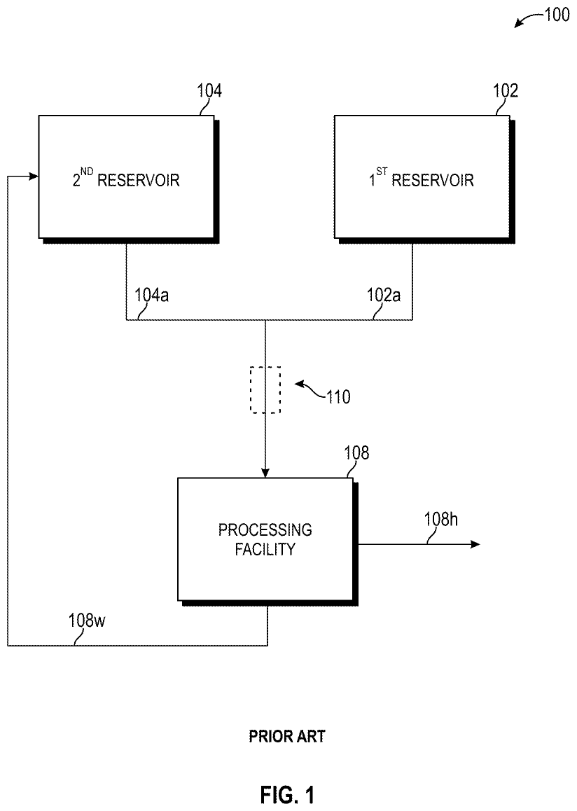

A diagram of a comparative example system is shown in FIG. 1. System 100 includes wherein two hydrocarbon reservoirs, a first reservoir 102 and a second reservoir 104, each supply a production stream, shown as 102a and 104a respectively. Upon being removed from the reservoirs 102 and 104, the production streams 102a and 104a are combined before entering a processing facility 108. However, combination of production streams from different reservoirs increases the likelihood of scale formation, which may occur directly at the combination as indicated by dashed box 110 or within the processing facility 108. Additionally, a portion of separated water 108w from the processing facility may optionally be reintroduced to one or both reservoirs (shown here as the second reservoir 104), the hydrocarbons separated from the production stream in processing facility 108 are sent via 108h for further separation and refinement.

The first reservoir 102 and the second reservoir 104 may be reservoirs that are calcium-rich and sulfate-rich, respectively. “Rich” (e.g., calcium-rich or sulfate-rich), and grammatical variants thereof, as used herein refers to wherein a subterranean reservoir includes formation water that has a concentration of the species in question (e.g., calcium, sulfur, sulfate, the like) of 100 ppm (parts per million) or greater (or 250 ppm or greater, or 450 ppm or greater, or 500 ppm or greater, or 1000 ppm or greater, or 2500 ppm or greater, or 5000 ppm or greater, or 10,000 ppm or greater, or 20,000 ppm or greater, or 30,000 ppm or greater, or 35,000 ppm or greater, or 250 ppm to saturated, or 500 ppm to saturated, or 1000 ppm to saturated, or 2500 ppm to saturated, or 5000 ppm to saturated, or 100 ppm to 35,000 ppm, or 100 ppm to 30,000 ppm, or 100 ppm to 10,000 ppm, or 500 ppm to 10,000 ppm, or 1000 ppm to 10,000 ppm, or 5000 ppm to 1000 ppm). “Calcium-rich” may preferably indicate a concentration of 35,000 ppm or greater. “Sulfate-rich” may preferably indicate a concentration of 450 ppm or greater. “Saturated,” as used herein refers to a concentration of a fluid in which the maximum amount of species in question (e.g., calcium, sulfur, the like) is dissolved at atmospheric pressure and 25° C. One of skill in the art will recognize that when a calcium-rich stream is put into contact with a sulfate-rich stream, they may form solid calcium sulfate, which will then build up as scale in pipelines and production equipment. Other well-known scales associated with hydrocarbon production include calcium carbonate, calcium phosphate, and magnesium silicate. As a result, the comingling of more than one production stream within the system may result in significant scaling, requiring remediation, which can be costly.

The present disclosure provides methods and systems for processing of produced water in a sustainable fashion that eliminates or reduces the dependence on scale inhibition chemicals and is performed in a dedicated system that can be implemented in existing hydrocarbon processing operations. The methods and systems of the present disclosure additionally enable significant environmental benefits, allowing for carbon dioxide (a greenhouse gas) use and sequestration, as well as sustainable water treatment and environmental release.

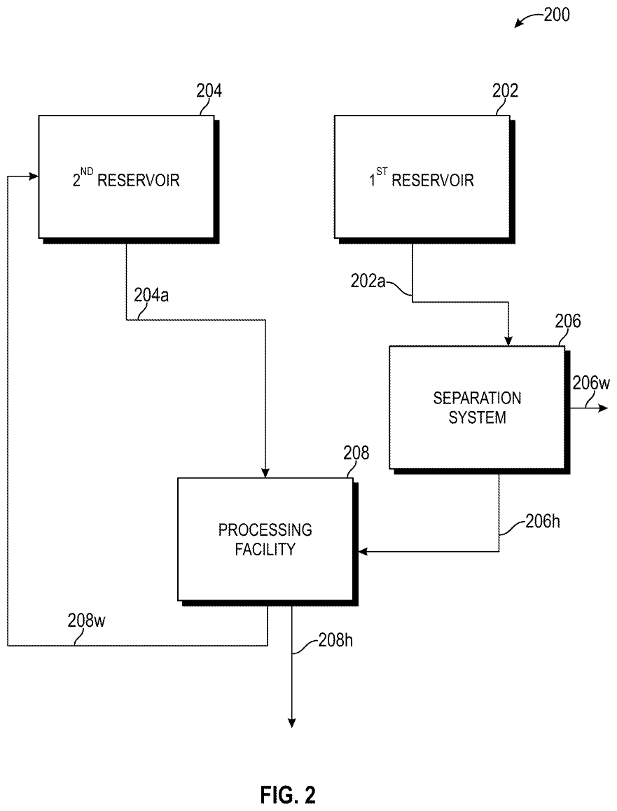

A diagram of a nonlimiting example system is shown in FIG. 2. System 200 includes wherein two hydrocarbon reservoirs, a first reservoir 202 and a second reservoir 204, supply a first production stream 202a and a second production stream 204a, respectively. Upon being removed from the reservoirs 202 and 204, the production streams from one of the reservoirs is directed to a separation system to remove the aqueous components from that production stream. As shown in FIG. 2, the first production stream 202a is directed to separation system 206 where the aqueous components are removed via line 206w and the hydrocarbon components are sent via 206h for further processing in processing facility 208. While FIG. 2 shows processing of the first production stream 202a, embodiments of the present invention cold just as easily be envisioned to process second production stream 204a. It should be noted that combining first production stream 202a and second production stream 204a for treatment in separation system 206 should be avoided for at least the reasons described above regarding the formation of scale. However, once either first production stream 202a or second production stream 204a has been treated to remove aqueous components, they can be combined for further processing.

By way of example, if first production stream 202a is calcium-rich and second production stream 204a is sulfate-rich, treatment of production stream 202a will remove the calcium at 206w, and the remaining hydrocarbon stream 206h will not be calcium-rich and may then be combined with the sulfate-rich second production stream 204a in the processing facility 208 without substantial risk of scale formation.

One of the first operations of processing facility 208 will be to remove the aqueous components from second production stream 204a. Those aqueous components may then be sent for further treatment or, as shown, returned to the reservoir 204 via aqueous stream 208w. While FIG. 2 shows aqueous stream 208w as returned to the reservoir, it is also envisioned that aqueous stream 208w may be sent for further processing. Of note, aqueous stream 208w and aqueous stream 206w should not be processed together until one or both has been treated to remove the potential scale component. Additionally, a hydrocarbon stream 208h comprising remaining hydrocarbons from processing facility 208 may be directed for further processing or otherwise further use.

The processing facility 208 generally refers to a refining operation and may comprise any suitable processing facility for hydrocarbon operations including, but not limited to, a gas-oil separation plant, a hydro-treatment plant (e.g., an industrial hydro-treatment plant, a civil hydro-treatment plant), a power plant (e.g., a cogeneration plant), the like, or any combination thereof.

The separation system 206 may have components including, but not limited to, a cyclonic separator (e.g., a cyclone-coalescer), a skimmer (e.g., an atmospheric skimmer), the like, or any combination thereof. The separation system may preferably comprise a cyclone-coalescer fluidly connected to an atmospheric skimmer. The cyclone-coalescer may comprise any suitable cyclonic separation system for separation of hydrocarbons and water. The cyclone-coalescer may be an inline separation system. A hydrocarbon output (the hydrocarbon stream) from the cyclone-coalescer may be further used in hydrocarbon processing operations, and an aqueous output of the cyclone-coalescer may be fed to the atmospheric skimmer. The aqueous output of the cyclone-coalescer may include oil impurities, necessitating further processing via the atmospheric skimmer. The atmospheric skimmer may comprise any suitable skimmer for separation of aqueous and oil. The aqueous output of the atmospheric skimmer may form an aqueous stream and further be processed. The oil separated in the atmospheric skimmer may be supplied to a hydrocarbon processing facility for use (e.g., for use with hydrocarbon processing operations previously described). Both the cyclone-coalescer and the atmospheric skimmer may preferably operate at atmospheric pressure and temperature conditions; however, other temperatures and pressures are additionally contemplated.

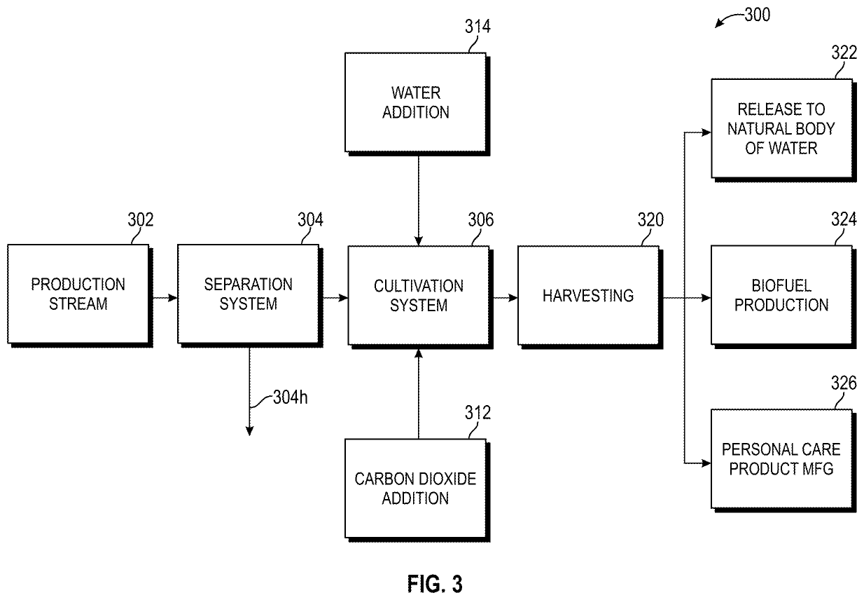

The separation system described herein may be integrated as part of integrated methods and systems of the present disclosure. A flow diagram of a nonlimiting example integrated method of the present disclosure is shown in FIG. 3. Method 300 includes wherein the previously described separation system is integrated for purposes of treating production stream (including water, e.g., formation water). The production stream 302 is a mixture of aqueous fluid and hydrocarbons the same as described above with reference to 102a/202a and 104a/204a. At block 304 the production stream 302 is separated to remove hydrocarbons via 304h with the aqueous components of the fluids proceeding from separation system 304 to cultivation system 306.

At block 306, the separated water may be transferred to a system for cultivation using algae. The algae may be provided carbon dioxide 312 and additional water 314. Following cultivation 306, harvesting of algae 320 may take place. Subsequently, algae constituents (e.g., algae solids, algae lipids, algae liquids, the like, or any combination thereof) may be used further, including for release to a natural body of water 322, for biofuel production 324, for personal care products manufacturing 326, the like, or any combination thereof.

Cultivation of algae may take place in any suitable environment including any suitable temperature and pressure. Example suitable environments may include, but are not limited to, an open raceway pond, a photobioreactor, the like, or any combination thereof. Algae growth may require an environment with exposure to light (e.g., sunlight). Algae used in cultivation may include any suitable variety and may be cultivated at any suitable conditions. As a nonlimiting example, algae cultivated may comprise microalgae. As another nonlimiting example, algae may be cultivated in water at a temperature from 25° C. to 35° C. at atmospheric pressure. The cultivation environment may additionally be supplied with additional water 314, which may preferably be wastewater. Such wastewater may originate from any suitable source including, but not limited to, from a gas-oil separation plant (e.g., boiler blowdown water, reject reverse osmosis water, recycle water, the like, or any combination thereof), an industrial facility, the like, or any combination thereof. The cultivation environment may additionally be supplied carbon dioxide gas. The carbon dioxide gas may originate from any suitable source including, but not limited to, flue gas from an industrial facility and/or gas-oil separation plant. The use of carbon dioxide by the algae may allow for reduction in greenhouse gas emissions from the source of the carbon dioxide, as the carbon dioxide may be utilized by the algae and at least a portion of the carbon dioxide may be thus not released to the atmosphere. The growth of the algae may, without being bound by theory, be increased by the previously separated water, the added waste water, the carbon dioxide, or a combination thereof. Continuing to not be bound by theory, such an increase in algae growth may result from minerals (e.g., calcium, phosphorous, sulfate, the like, or any combination thereof) within the separated water and/or waste water, and additionally such increased algae growth may be promoted by increased concentrations of carbon dioxide. It should be noted that parameters of the environment suitable for cultivation may depend on factors including, but not limited to, the algae type, the cultivation method, the cultivation duration, the contents of the separated water and/or the additional water, the like, or any combination thereof.

Harvesting of algae may be performed using any suitable means known in the art, including, but not limited to, straining, filtering, cyclonic separation, the like, or any combination thereof. Upon harvesting, algae liquids comprising water previously used in algae growth may have a purity level acceptable for release to a natural body of water, including, but not limited to, a wetland, stream, bayou, lake, river, subterranean aquifer, ocean, marsh, the like, or any combination thereof. Upon harvesting, algae solids and lipids may be used for further processing. As a nonlimiting example, the algae lipids may be extracted for use in biofuel (e.g., biodiesel) production. Suitable integrated methods of biofuel production from algae will be able to be implemented by those skilled in the art with the benefit of the present discourse. As another nonlimiting example, the algae solids may be processed into dry biomass and may be further used in personal care products manufacturing including, but not limited to, the manufacture of vitamins, marine food, cosmetics, the like, or any combination thereof.

It should be noted that there may be additional equipment including, but not limited to, valves, pipelines, actuators, pumps, temperature sensors, electronic controllers, and the like that are customarily employed in water treatment and/or hydrocarbon processing operations that, for the purpose of simplified schematic illustrations and description, may not be shown or described within the present disclosure.

### Additional Embodiments

Embodiment 1. An integrated method comprising: providing a first production stream and a second production stream, wherein both the first production stream and the second production stream comprise hydrocarbons and water, and wherein the first production stream contains carbonates and/or sulfates and the second production stream contains minerals, such that if the first production stream and the second production stream were combined scale would form; either (i) separating the first production stream into a first aqueous stream and a first hydrocarbon stream, wherein the first aqueous stream comprises the carbonates and/or sulfates or (ii) separating the second production stream into a second aqueous stream and a second hydrocarbon stream, wherein the second aqueous stream comprises the minerals; and combining the first hydrocarbon stream and the second production stream for further processing.

Embodiment 2. The integrated method of Embodiment 1, further comprising cultivating algae in a fluid comprising the first aqueous stream.

Embodiment 3. The integrated method of Embodiment 2, further comprising supplying additional water to the algae, supplying carbon dioxide to the algae, or any combination thereof.

Embodiment 4. The integrated method of Embodiment 3, wherein the carbon dioxide is provided as flue gas from a hydrocarbon processing operation.

Embodiment 5. The integrated method of Embodiment 3 or 4, wherein the additional water comprises industrial waste water.

Embodiment 6. The integrated method of any one of Embodiments 2-5, further comprising harvesting the algae to produce harvested algae, wherein the harvested algae comprises algae solids, algae liquids, algae lipids, or any combination thereof.

Embodiment 7. The integrated method of Embodiment 6, further comprising manufacturing a personal care product from the algae solids.

Embodiment 8. The integrated method of Embodiment 6 or 7, further comprising manufacturing a biofuel from the algae lipids.

Embodiment 9. The integrated method of any one of Embodiments 6-8, further comprising releasing the algae liquids to a natural body of water.

Embodiment 10. The integrated method of any one of Embodiments 2-9, wherein cultivating the algae comprises cultivation in an open raceway pond, photobioreactor, or any combination thereof.

Embodiment 11. The integrated method of any one of Embodiments 1-10, wherein separating the first production stream and/or separating the second production stream comprises using a cyclone-coalescer fluidly connected to a skimmer.

Embodiment 12. An integrated method comprising: providing a first production stream and a second production stream, wherein both the first production stream and the second production stream comprise hydrocarbons and water; wherein the first production stream contains carbonates and/or sulfates and the second production stream contains minerals, such that if the first production stream and the second production stream were combined scale would form; separating the first production stream into a first aqueous stream and a first hydrocarbon stream, wherein the first aqueous stream comprises water and carbonates and/or sulfates; combining the first hydrocarbon stream and the second production stream for further processing; cultivating algae in a fluid comprising the first aqueous stream; and harvesting the algae to produce harvested algae, wherein the harvested algae comprises algae solids, algae liquids, algae lipids, or any combination thereof.

Embodiment 13. The integrated method of Embodiment 12, further comprising manufacturing a personal care product from the algae solids.

Embodiment 14. The integrated method of Embodiment 12 or 13, further comprising manufacturing a biofuel from the algae lipids.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. An integrated method comprising:
providing a first production stream and a second production stream,
wherein both the first production stream and the second production stream comprise hydrocarbons and water, and
wherein the first production stream contains carbonates and/or sulfates and the second production stream contains minerals, such that if the first production stream and the second production stream were combined scale would form;
either (i) separating the first production stream into a first aqueous stream and a first hydrocarbon stream, wherein the first aqueous stream comprises the carbonates and/or sulfates or (ii) separating the second production stream into a second aqueous stream and a second hydrocarbon stream, wherein the second aqueous stream comprises the minerals; and
combining the first hydrocarbon stream and the second production stream for further processing.

2. The integrated method of claim 1, further comprising cultivating algae in a fluid comprising the first aqueous stream.

3. The integrated method of claim 2, further comprising supplying additional water to the algae, supplying carbon dioxide to the algae, or any combination thereof.

4. The integrated method of claim 3, wherein the carbon dioxide is provided as flue gas from a hydrocarbon processing operation.

5. The integrated method of claim 3, wherein the additional water comprises industrial waste water.

6. The integrated method of claim 2, further comprising harvesting the algae to produce harvested algae, wherein the harvested algae comprises algae solids, algae liquids, algae lipids, or any combination thereof.

7. The integrated method of claim 6, further comprising manufacturing a personal care product from the algae solids.

8. The integrated method of claim 6, further comprising manufacturing a biofuel from the algae lipids.

9. The integrated method of claim 6, further comprising releasing the algae liquids to a natural body of water.

10. The integrated method of claim 2, wherein cultivating the algae comprises cultivation in an open raceway pond, photobioreactor, or any combination thereof.

11. The integrated method of claim 1, wherein separating the first production stream and/or separating the second production stream comprises using a cyclone-coalescer fluidly connected to a skimmer.

12. An integrated method comprising:
providing a first production stream and a second production stream,
wherein both the first production stream and the second production stream comprise hydrocarbons and water;
wherein the first production stream contains carbonates and/or sulfates and the second production stream contains minerals, such that if the first production stream and the second production stream were combined scale would form;
separating the first production stream into a first aqueous stream and a first hydrocarbon stream, wherein the first aqueous stream comprises water and carbonates and/or sulfates;
combining the first hydrocarbon stream and the second production stream for further processing;
cultivating algae in a fluid comprising the first aqueous stream; and
harvesting the algae to produce harvested algae, wherein the harvested algae comprises algae solids, algae liquids, algae lipids, or any combination thereof.

13. The integrated method of claim 12, further comprising manufacturing a personal care product from the algae solids.

14. The integrated method of claim 13, further comprising manufacturing a biofuel from the algae lipids.
